(19) United States
(12) Patent Application Publication
(10) Pub. No.: US 2026/0332974 A1
(43) Pub. Date: Oct. 22, 2026

(54) METHOD FOR MANUFACTURING AN INDIVIDUALLY ADAPTED HEARING INSTRUMENT AND HEARING INSTRUMENT SYSTEM HAVING SUCH A HEARING INSTRUMENT

(71) Applicant: Sivantos Pte. Ltd., Singapore (SG)

(72) Inventor: Thilo VON MANSBERG, Erlangen (DE)

(21) Appl. No.: 19/642,876

(22) Filed: Apr. 9, 2026

(30) Foreign Application Priority Data
Apr. 17, 2025 (DE) 10 2025 115 178.4

(51) Int. Cl. H04R 25/00; H04R 1/10; H04R 1/1025; H04R 25/02

(52) U.S. Cl. CPC H04R 25/659; H04R 1/1016; H04R 1/1025; H04R 1/1041; H04R 1/1075; H04R 25/02; H04R 25/602; H04R 25/603; H04R 25/609

(57) ABSTRACT

A method for manufacturing individually adapted hearing instruments includes creating or providing a model of the cavum conchae and external auditory canal of an ear of a user of the instrument and, based on the model, creating an earpiece model for the instrument. The earpiece model includes a first region for intended insertion into the external auditory canal, and a second region, connected to the first region, for arrangement in the cavum conchae. Dimensions of a receiving chamber of a charging device for the instrument are provided. A dome having a charging contact arrangement is in the receiving chamber. A counter-contact arrangement, for contacting the charging contact arrangement when the instrument is disposed in the receiving chamber, is positioned in a sub-region of the second region of the earpiece model facing a portion of the auricle surrounding the cavum conchae. The instrument is manufactured based on the earpiece model.

### CROSS-REFERENCE TO RELATED APPLICATION

This application claims the priority, under 35 U.S.C. § 119, of German Patent Application DE 10 2025 115 178.4, filed Apr. 17, 2025; the prior application is herewith incorporated by reference in its entirety.

### FIELD AND BACKGROUND OF THE INVENTION

The invention relates to a method for manufacturing an individually adapted hearing instrument. The invention further relates to a hearing instrument system including such a hearing instrument.

Hearing instruments are generally used to output an audio signal to the auditory system of the wearer of the hearing instrument. The output is performed by an output transducer, typically acoustically via airborne sound using a loudspeaker (herein also referred to as an “earphone” or “receiver”). Such hearing instruments are often employed as so-called hearing assistive devices (also referred to simply as hearing aids). The hearing instruments typically include an acoustic input transducer, in particular a microphone, and a signal processor configured to process an input signal (also referred to as a microphone signal) generated from ambient sound by the input transducer by applying at least one signal processing algorithm, typically stored in a user-specific manner, such that a hearing impairment of the wearer of the hearing instrument is at least partially compensated. In particular in the case of a hearing assistive device, the output transducer may, in addition to being a receiver, alternatively be what is known as a bone conduction receiver or a cochlear implant configured to mechanically or electrically couple the audio signal into the auditory system of the wearer. In addition, there are hearing instruments which protect or improve the hearing ability of users with normal hearing, for example by enabling improved speech intelligibility in complex listening situations. Such devices are also referred to as “personal sound amplification products” (PSAPs). The term hearing instruments also encompasses devices such as so-called tinnitus maskers, headsets, headphones, and the like.

Typical configurations of hearing instruments, in particular hearing aids, are behind-the-ear (“BTE”) and in-the-ear (“ITE”) hearing instruments. These terms refer to the intended wearing position. Behind-the-ear hearing instruments have a (main) housing that is worn behind the auricle. A distinction can be made between models in which the receiver is disposed within that housing-the sound is typically output to the ear via a sound tube worn within the auditory canal- and models having an external receiver disposed in the auditory canal. In-the-ear hearing instruments, in contrast, have a housing that is worn in the auricle or even entirely within the auditory canal.

For ITE hearing instruments, there are embodiments in which the hearing instrument is positioned and held in the ear canal by a soft dome. In that case, apart from selecting an appropriate dome size, no individual customization is required or provided. Other embodiments of ITE hearing instruments, however, include an individually manufactured earpiece in which at least a majority, and typically all, of the components of the hearing instrument are disposed. The earpiece thus forms a housing individually adapted to the user.

In order to increase user comfort, in particular to avoid nearly daily battery replacement in comparatively small ITE hearing instruments, secondary cells (rechargeable batteries) are increasingly used. Charging of the secondary cell is performed by a charging device, which is typically configured in the form of a receptacle into which the entire hearing instrument is inserted. Although wireless charging methods are known and are also used in some cases for hearing instruments, a galvanic contact for transmitting the charging energy is advantageous, since this typically results in lower losses and also allows the electronic components of the hearing instruments to be kept simpler. Since ITE hearing instruments are configured to be as visually inconspicuous as possible, arranging charging contacts (which are typically metallic and therefore shiny and relatively visible) on a surface facing the outside of the ear is undesirable. On the other hand, a surface facing outward from the ear generally provides sufficient installation space for a flat surface, which is often formed by a cover plate, also referred to as a “faceplate.” That surface is therefore suitable for positioning the charging contacts. In particular, that avoids the need to adapt the shape of a charging cradle in the charging device to the individual shape of the earpiece, such that the charging device can be manufactured as a mass-produced product without consideration of the individual shape of the respective hearing instrument.

### SUMMARY OF THE INVENTION

It is accordingly an object of the invention to provide a method for manufacturing an individually adapted hearing instrument and a hearing instrument system having such a hearing instrument, which overcome the hereinafore-mentioned disadvantages of the heretofore-known methods and systems of this general type and which enable the manufacture of an improved hearing instrument.

With the foregoing and other objects in view there is provided, in accordance with the invention, a method for manufacturing an individually adapted hearing instrument in which a model, preferably a virtual model, of at least the auricular cavity (“cavum conchae”) and the external auditory canal of the ear of a user of the hearing instrument (i.e., a person using the hearing instrument) is first created or provided. This model is created, for example, on the basis of a physical impression with subsequent scanning or by scanning the ear itself. An earpiece model for the hearing instrument is created on the basis of this model. The earpiece model includes a first region configured for insertion at least into the external auditory canal and a second region connected to the first region and configured for arrangement in the auricular cavity. In particular, these two regions are created on the basis of the model. Furthermore, at least dimensions of a receiving chamber of a charging device for the hearing instrument are provided. A dome is disposed in the receiving chamber, in particular protruding from a base of the receiving chamber, the dome having a charging contact arrangement disposed at its free end and extending into the receiving chamber. Preferably, the dimensions are provided as part of a virtual model of at least the receiving chamber, that is, as part of a virtual model of the receiving chamber itself. A counter-contact arrangement configured to contact the charging contact arrangement when the hearing instrument is disposed as intended in the receiving chamber is then positioned in a sub-region of the second region of the earpiece model that faces a portion of the auricle surrounding the cavum conchae. The counter-contact arrangement thus forms part of the earpiece model. The hearing instrument is subsequently manufactured on the basis of the earpiece model.

Advantageous embodiments and further developments of the invention, some of which are inventive in their own right, are set forth in the dependent claims and in the following description.

A virtual model is understood in particular to mean a 3D model that can be used for a CAD or CAM program. Such a 3D model may, for example, be formed by a point cloud, a mesh, or the like. Corresponding virtual models are known in the prior art.

According to a preferred embodiment, the position of the counter-contact arrangement in the sub-region of the second region (of the earpiece model) is selected such that, when the hearing instrument is disposed as intended at the charging contact arrangement, no collision of the hearing instrument with a wall of the receiving chamber of the charging device occurs. Avoiding a collision with the wall of the receiving chamber enables defined contact between the counter-contact arrangement and the charging contact arrangement, in particular without forces that would lead to an undesirable displacement of the counter-contact arrangement relative to the charging contact arrangement.

Preferably, the position of the counter-contact arrangement in the sub-region of the second region is selected such that, when the hearing instrument is positioned as intended in the ear, the counter-contact arrangement is not visible, in particular from an outer side of the ear. This results in a particularly inconspicuous appearance. This sub-region is also referred to below as the “underside” of the second region or of the earpiece.

As a result of the counter-contact arrangement thus being oriented toward the auricular cavity, it is also at least approximately aligned (in particular relative to a side surface of the user's head in which the ear is located) in the same direction as a peg-shaped or dome-shaped projection of the earpiece that forms the second region and is inserted, in the intended wearing position, at least into the external auditory canal. This projection is often exposed, at least at its free end, to comparatively heavy contamination due to the wearing position, for example cerumen, skin oils, etc. However, due to the arrangement of the counter-contact arrangement described above, this projection is, when the hearing instrument is disposed as intended in the receiving chamber, likewise oriented (i.e., in the same manner as the counter-contact arrangement) toward the base of the receiving chamber and is thus at least not directly visible when viewing the hearing instrument.

Preferably, the counter-contact arrangement is configured for magnetic retention on the charging contact arrangement. In other words, the charging contact arrangement and the counter-contact arrangement attract one another magnetically and, when properly contacted, exert a retaining force between them. According to an expedient variant of the method, in this case the position of the counter-contact arrangement in the sub-region of the second region is selected such that the magnetic retaining force between the counter-contact arrangement and the charging contact arrangement is sufficient to hold the hearing instrument, formed on the basis of the earpiece model, on the dome.

Expediently, when selecting the position of the counter-contact arrangement, positions of electrical and electronic components within an earpiece of the hearing instrument defined by the earpiece model are taken into account. In particular, the respective mass of the components and their influence on the center of gravity of the hearing instrument are determined and taken into consideration. For example, the position of the counter-contact arrangement is selected such that the center of gravity of the hearing instrument is disposed at least approximately along a longitudinal axis of the dome extending through the charging contact arrangement, in particular along a vertical axis. As a result, even a comparatively low magnetic retaining force may be sufficient to hold the hearing instrument “in balance” on the dome. A slight deviation of the center of gravity from the vertical (for example up to 2 or 3 mm) may, however, be compensated by the magnetic retaining force, depending on its magnitude.

Preferably, the receiving chamber of the charging device (preferably the entire charging device) is mass-produced. Thus, in the manufacture of the receiving chamber, the respective individual earpiece model is, in particular, not taken into account. Nevertheless, the receiving chamber is configured on the basis of a statistically determined envelope of hearing instruments (a theoretical outer boundary encompassing a plurality of external dimensions of hearing instruments). That is, a survey of earpiece shapes, in particular their external dimensions, is carried out, and the receiving chamber is configured and constructed such that the earpieces fit into the receiving chamber. Optionally, a maximum size of the recorded earpiece shapes or at least an average value is used for this purpose. Preferably, however, the receiving chamber is configured to be as small as possible (for example on the basis of the average value) in order to keep the charging device as compact as possible.

According to a further expedient variant of the method, the charging contact arrangement and the counter-contact arrangement are each configured as a concentric arrangement of positive and negative charging contacts. This results in a compact form of the respective contact arrangement that can be described, in general terms, as point-like. An outer diameter of the respective contact arrangement is, for example, 1 to 3 millimeters, in particular up to 2 millimeters.

According to a further expedient variant of the method, an optical modeling interface is used, on which a positioning of the earpiece model is displayed for the intended arrangement of the hearing instrument at the charging contact arrangement. In this way, a collision with a wall of the receiving chamber can be checked visually, in particular by a designer or a specialist for adapting the earpiece. If necessary (i.e., in the event of a collision), the position of the counter-contact arrangement in the sub-region of the second region of the earpiece model is modified such that the earpiece model is positioned differently on the dome and the collision can thereby be avoided. Optionally, this procedure is carried out iteratively, for example by placing or shifting the counter-contact arrangement and subsequently displaying the earpiece model again and positioning it on the dome.

Optionally, as a further development of the method variant described above, a collision is indicated by an optical marking, in particular a color-highlighted marking. This simplifies detection of the collision by the designer or specialist.

Further optionally, in particular as an alternative to the display and manual positioning or adjustment performed by the designer or specialist described above, a machine learning system, for example a neural network, a decision tree, or the like, may be used to perform the positioning of the counter-contact arrangement and the collision check described above.

With the objects of the invention in view, there is concomitantly provided a hearing instrument system, comprising at least one hearing instrument, preferably the hearing instrument described above, having an individually manufactured earpiece (preferably in accordance with the above description). Furthermore, the hearing instrument system includes a charging device, in particular the one described above, which has a receiving chamber for the hearing instrument, wherein a dome having the (in particular free-end disposed) charging contact arrangement for the corresponding counter-contact arrangement of the hearing instrument is disposed in the receiving chamber. The charging device is manufactured as a mass-produced product. The hearing instrument (in particular at least its earpiece) is individually adapted, wherein the counter-contact arrangement is positioned in a sub-region of the earpiece that faces a portion of the auricle surrounding the cavum conchae of a user.

The hearing instrument system in particular has the same features, or the features resulting from the corresponding method steps, as well as the advantages resulting therefrom, as the method described above.

Here and in the following, in particular, the conjunction “and/or” is to be understood such that the features linked by this conjunction may be implemented both jointly and as alternatives to one another.

Other features which are considered as characteristic for the invention are set forth in the appended claims.

Although the invention is illustrated and described herein as embodied in a method for manufacturing an individually adapted hearing instrument and a hearing instrument system having such a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an individually adapted hearing instrument to be worn in the ear;

FIG. 2 is a bottom perspective view of a virtual model of a variant of the hearing instrument;

FIG. 3 is a perspective view of a virtual model of a charging device with a virtual model of a further variant of the hearing instrument;

FIG. 4 is a perspective view according to FIG. 3 of a further variant of the virtual model of the hearing instrument;

FIG. 5 is a perspective view of a virtual model of a part of the charging device and a virtual model of a further variant of the hearing instrument;

FIG. 6 is a perspective view according to FIG. 3 of the virtual model of the charging device with a lid and with the virtual model of the hearing instrument; and

FIG. 7 is a block diagram of a flow chart for a method for manufacturing the hearing instrument.

### DETAILED DESCRIPTION OF THE INVENTION

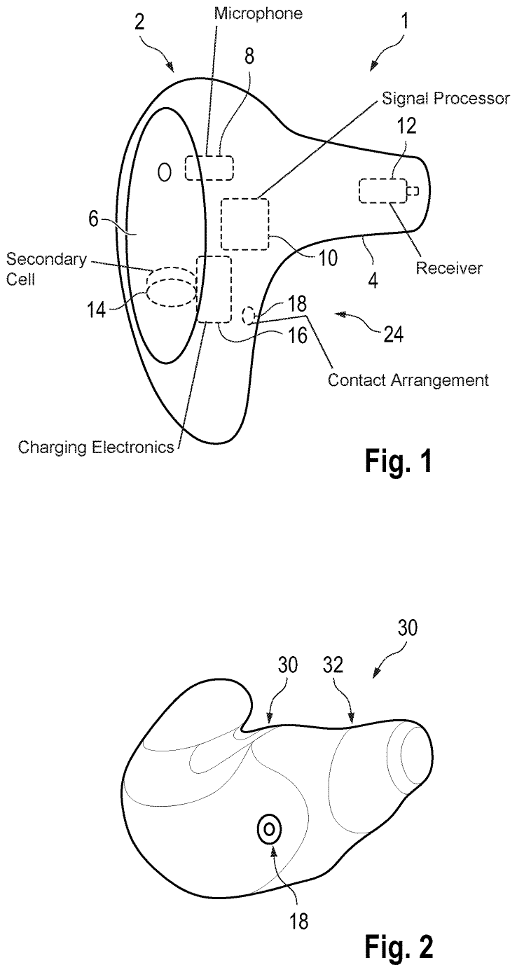

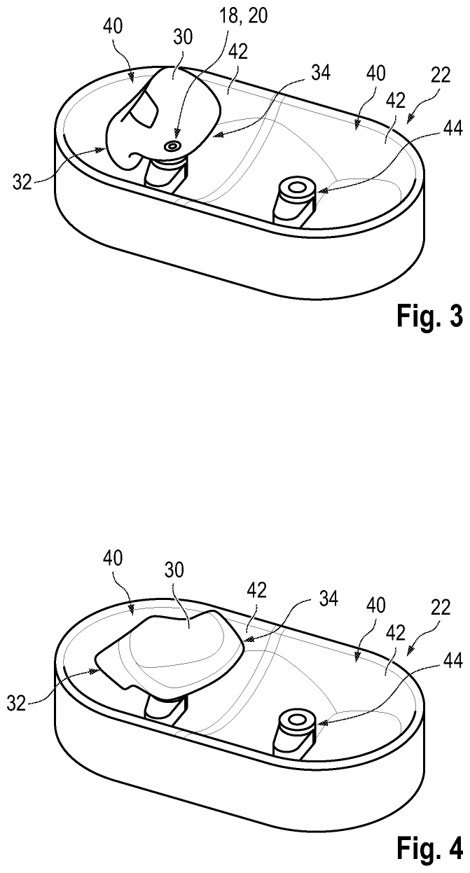

Referring now in detail to the figures of the drawings, in which analogous parts are always provided with the same reference symbols, and first, particularly, to FIG. 1 thereof, there is seen a hearing instrument shown diagrammatically, which is intended to be worn in an ear of a person using the hearing instrument. The hearing instrument is referred to below as “ITE 1.” The ITE 1 includes a housing 2, which is formed by an earpiece 4 that is individually adapted to the external auditory canal and the auricular cavity of the person (or user). The earpiece 4 encloses an interior space that is closed by a cover plate 6 forming part of the housing 2. Disposed in the interior space as electronic components are at least one microphone 8 for receiving ambient sounds, a signal processer 10, and a receiver 12. The signal processer 10 is configured for user-specific signal processing (for example frequency-dependent filtering and/or amplification) of the sounds captured by the microphone 8. The receiver 12, during intended operation, outputs the signals processed and provided by the signal processer 10 as airborne sound to the hearing of the person. For power supply, the ITE 1 includes a secondary cell 14 (i.e., a rechargeable battery). This is coupled to charging electronics 16, which control both the power supply of the signal processor 10 and the charging of the secondary cell 14. For supplying charging energy, the ITE 1 further includes a counter-contact arrangement 18, which is configured and provided for galvanic contact with a charging contact arrangement 20 of a charging device 22 (see FIG. 3).

The contact arrangement 18 includes two oppositely polarized contacts disposed concentrically with respect to one another. One contact is formed centrally as a pin or circular surface, while the other surrounds it in a ring-shaped manner. The charging contact arrangement 20 is of complementary configuration, wherein the central contact is formed as a pin, specifically as a spring-loaded contact pin (pogo pin), when the central contact of the contact arrangement 18 is formed as a circular surface, and vice versa. The contact arrangement 18 and the charging contact arrangement 20 are furthermore provided with magnetic material such that they attract one another. As a result, a magnetic retaining force is generated, which enables a galvanic contact sufficient for the charging process.

Since the contacts are typically brass-colored, copper-colored, or gold-colored and have a shiny appearance, the contact arrangement 18 is disposed on an underside 24 of the earpiece 4 that faces the auricle delimiting the cavum conchae (i.e., the body surface or wall of the auricle) in the intended wearing state. As a result, the contact arrangement 18 is concealed from the view of third parties when the ITE 1 is worn as intended.

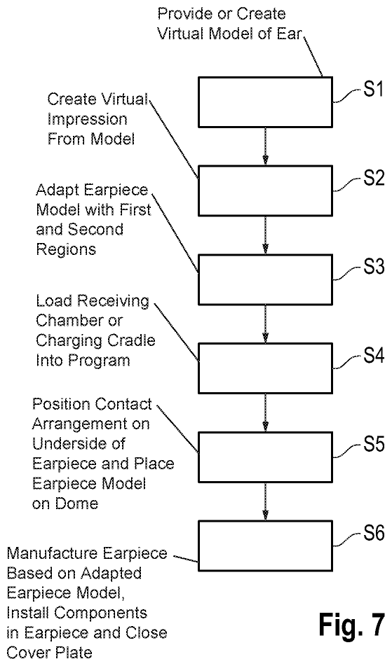

However, the ear shapes of individuals vary, in some cases considerably, such that the available surface area on an earpiece 4 individually adapted to a specific person is not uniform. For this reason, charging devices are often manufactured with insertion cradles individually adapted to the respective hearing instrument in order to hold the individually manufactured hearing instruments in the intended position during charging. The present invention aims, inter alia, to avoid the need for individual adaptation of such insertion cradles. For this purpose, a method for manufacturing the ITE 1 is described below with reference to FIG. 7 and FIGS. 2 to 6.

In a first method step S1, a virtual model of the cavum conchae and the external auditory canal is first provided or optionally created. For example, the ear of the person who will use the ITE 1 to be produced is captured using scanning methods, and the model is generated therefrom. In a second method step S2, a virtual “impression” is created from this model, which in turn forms a virtual earpiece model 30 (see, for example, FIG. 2) for the earpiece 4. In the present embodiment, the earpiece model 30 is formed as a mesh model, but may also be formed as other CAD models known in the prior art. The earpiece model 30 is subsequently trimmed virtually, in particular by removing regions that are not relevant for use as the earpiece 4. The derivation of the earpiece model 30 and its trimming may, for example, be carried out by a specialist on a computer having a corresponding input interface. Such a computer includes, in particular, at least a display on which the earpiece model 30 is visually represented. The computer further includes an input interface, for example a graphics tablet or the like, through the use of which the specialist can make modifications to the earpiece model 30. The earpiece model 30 is adapted in a step S3 such that it includes a first region 32 configured for insertion into the external auditory canal and a second region 34 that, in the intended wearing state, is seated in the cavum conchae.

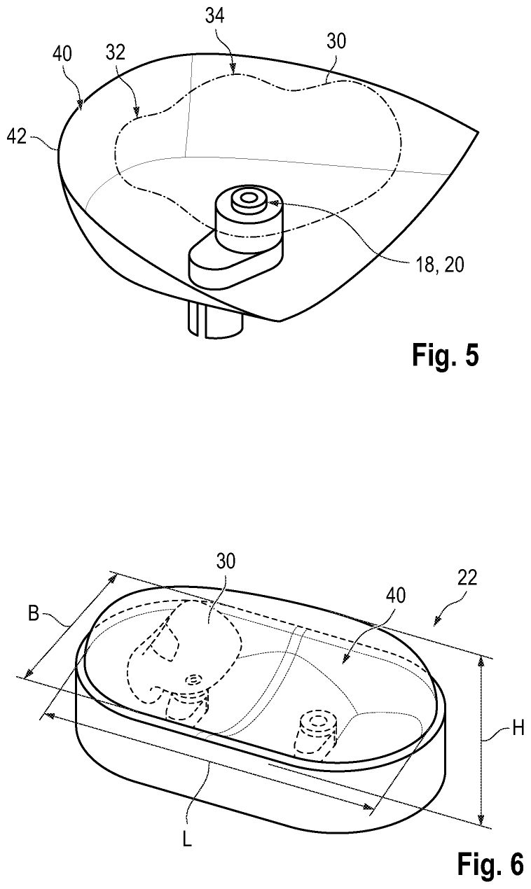

In a fourth method step S4, at least dimensions of a receiving chamber 40 (length L, width B, and height H), or more specifically the receiving chamber 40 itself or at least a charging cradle 42 delimiting the receiving chamber 40 on the bottom side (see FIG. 5), are loaded into a design or fitting program in which the specialist also edits the earpiece model 30. The charging cradle 42 and also the receiving chamber 40 (as well as the charging device 22) are mass-produced products that are not specifically adapted to an individually customized earpiece 4. Rather, the dimensions of the receiving chamber 40 and the charging cradle 42 are based on a plurality of empirically collected data relating to ear and earpiece geometries.

A dome 44 is formed in the charging cradle 42. The charging contact arrangement 20, projecting into the receiving chamber 40, is disposed at the end of the dome 44. In the intended charging state, the ITE 1 thus rests with the underside 24 of its earpiece 4 on the dome 44. During adaptation of the earpiece model 30, in a fifth method step S5, the contact arrangement 18 is positioned on the underside 24 of the second region 34. The earpiece model 30 is then (virtually) placed onto the associated dome 44. As can be seen in FIGS. 3 to 5, the charging cradle 42 includes a recessed region and a flatter region. The recessed region is configured to receive the first region 32 of the earpiece model 30 (and thus also of the earpiece 4). After the (virtual) positioning of the earpiece model 30 on the dome 44 such that the contact arrangement 18 is in intended contact with the charging contact arrangement 20, it is checked whether a collision of the earpiece model 30 with the charging cradle 42 occurs. If this is the case, the position of the contact arrangement 18 in the second region is shifted such that, upon intended contact with the charging contact arrangement 20, a modified rotational and/or translational orientation of the earpiece model 30 in the charging cradle 42 results. This iteration is repeated as necessary until no collision occurs.

Optionally, a position of a center of gravity of the ITE 1 formed on the basis of the earpiece model 30 is also taken into account. The center of gravity should be disposed at least approximately (for example with a deviation of up to 2 or 3 mm), in the intended charging state, in alignment with an axis of the dome 44 extending through the charging contact arrangement 20. This ensures that the magnetic retaining force is not overcome by a moment resulting from an excessively eccentrically located center of gravity and that the galvanic contact is maintained. For this purpose, certain electronic components, for example the signal processor 10 and/or the charging electronics 16, may optionally be repositioned within the earpiece 4.

FIGS. 3 to 5 show different variants of the earpiece model 30, resulting from anatomical differences, with the earpiece model 30 disposed in the charging cradle 42.

The dimensions of the receiving chamber 40 are approximately 40 to 50 mm in width B (i.e., ±5 mm), approximately 30 to 35 mm in height (i.e., ±3 mm), and approximately 35 to 37.5 mm in length L (i.e., ±2.5 mm), for two receiving chambers 40 disposed next to one another. That is, the total length L of the charging device 22 with two receiving chambers disposed next to one another is approximately 70 to 75 mm (i.e., ±5 mm).

In a final, sixth method step S6, the earpiece 4 is manufactured on the basis of the adapted earpiece model 30, and the contact arrangement 18 and the other components are correspondingly installed in the earpiece 4. Finally, the earpiece 4 is closed with the cover plate 6.

The subject of the invention is not limited to the exemplary embodiment described above. Rather, further embodiments of the invention may be derived from the above description by a person skilled in the art.

The following is a summary list of reference numerals and the corresponding structure used in the above description of the invention:
1 ITE
2 Housing
4 Earpiece
6 Cover plate
8 Microphone
10 Signal processor
12 Receiver
14 Secondary cell
16 Charging electronics
18 Contact arrangement
20 Charging contact arrangement
22 Charging device
24 Underside
30 Earpiece model
32 Region
34 Region
40 Receiving chamber
42 Charging cradle
44 Dome
S1-S6 Method step
B Width
H Height
L Length

1. A method for manufacturing an individually adapted hearing instrument, the method comprising:
creating or providing a model of at least the cavum conchae and the external auditory canal of an ear of a user of the hearing instrument;
creating, based on the model, an earpiece model for the hearing instrument, the earpiece model including a first region configured for intended insertion at least into the external auditory canal, and a second region connected to the first region and configured for arrangement in the cavum conchae;
providing dimensions of a receiving chamber of a charging device for the hearing instrument, including a dome having a charging contact arrangement disposed in the receiving chamber;
positioning a counter-contact arrangement, configured for contacting the charging contact arrangement when the hearing instrument is disposed as intended in the receiving chamber, the counter-contact arrangement being disposed in a sub-region of the second region of the earpiece model facing a portion of the auricle surrounding the cavum conchae; and
manufacturing the hearing instrument based on the earpiece model.

2. The method according to claim 1, which further comprises carrying out the positioning of the counter-contact arrangement in the sub-region of the second region to ensure that, when the hearing instrument is disposed as intended at the charging contact arrangement, no collision of the hearing instrument with a wall of the receiving chamber of the charging device occurs.

3. The method according to claim 1, which further comprises configuring the counter-contact arrangement for magnetic retention on the charging contact arrangement, and carrying out the positioning of the counter-contact arrangement in the sub-region of the second region to ensure that a magnetic retaining force between the counter-contact arrangement and the charging contact arrangement is sufficient to hold the hearing instrument, manufactured based on the earpiece model, on the dome.

4. The method according to claim 3, which further comprises carrying out the positioning of the counter-contact arrangement by taking into account positions of electrical and electronic components within an earpiece of the hearing instrument defined by the earpiece model.

5. The method according to claim 1, which further comprises mass-producing the receiving chamber of the charging device.

6. The method according to claim 5, which further comprises carrying out the mass-producing of the receiving chamber without taking individual earpiece models into account.

7. The method according to claim 1, which further comprises carrying out the positioning of the counter-contact arrangement in the sub-region of the second region to ensure that when the hearing instrument is positioned as intended in the ear, the counter-contact arrangement is not visible.

8. The method according to claim 1, which further comprises using a concentric arrangement of positive and negative charging contacts as the charging contact arrangement and as the counter-contact arrangement.

9. The method according to claim 1, which further comprises using an optical modeling interface on which a positioning of the earpiece model is displayed when the hearing instrument is disposed as intended at the charging contact arrangement, in order to enable a visual check for a collision with a wall of the receiving chamber and, if necessary, changing the position of the counter-contact arrangement in the sub-region of the second region of the earpiece model.

10. A hearing instrument system, comprising:
at least one individually adapted hearing instrument having an individually manufactured earpiece and a counter-contact arrangement positioned in a sub-region of said earpiece facing a portion of the auricle of a user surrounding the cavum conchae;
a charging device having a receiving chamber for said at least one hearing instrument, said charging device being manufactured as a mass-produced product; and
a dome having a corresponding charging contact arrangement for said counter-contact arrangement, said dome being disposed in said receiving chamber.

11. A hearing instrument system manufactured according to claim 1, the hearing instrument system comprising:
at least one individually adapted hearing instrument having an individually manufactured earpiece and a counter-contact arrangement positioned in a sub-region of said earpiece facing a portion of the auricle of a user surrounding the cavum conchae;
a charging device having a receiving chamber for said at least one hearing instrument, said charging device being manufactured as a mass-produced product; and
a dome having a corresponding charging contact arrangement for said counter-contact arrangement, said dome being disposed in said receiving chamber.
